(19) United States
(12) Patent Application Publication
(10) Pub. No.: US 2018/0012304 A1
(43) Pub. Date: Jan. 11, 2018

(54) METHOD AND SYSTEM FOR CONTROLLING INVESTMENT POSITION RISKS

(71) Applicant: Danming Chang, Dandong (CN)

(72) Inventor: Danming Chang, Dandong (CN)

(21) Appl. No.: 15/328,031

(22) PCT Filed: Feb. 18, 2016
(86) PCT No.: PCT/CN2016/074076

§ 371 Date: May 31, 2017

(30) Foreign Application Priority Data
Mar. 2, 2015 (CN) 201510091118.4

(51) Int. Cl. G06Q 40/06

(52) U.S. Cl. CPC G06Q 40/06

(57) ABSTRACT

A method and system for controlling investment position risks, which are applied to the field of financial investment, and are particularly applicable to high-risk and lever trading investment modes, so as to solve the problem of risk control for position weight during a investment trading of an investor, overcome mental states of greed and fear, achieve the optimal income in a limited risk range while position blast is prevented, and improve the efficiency of investment. The system is simple and convenient in operation, a user only need to input two groups of four data comprising preference parameters and trading parameters, the system can calculate, by means of a group of mathematical models, a position value of the optimal risk-income ratio meeting the risk preference requirements of the investor under the current trading condition, the position value of the optimal risk-income ratio is converted into the specific trading number of a corresponding contract, and the user determines to execute the trading by clicking confirmation, or abandons the trading by clicking cancel and turns back.

### TECHNICAL FIELD

Applied to the financial investment field, especially for high-risk and leveraged investments.

### BACKGROUND

In recent years, the rapid development of quantitative investment, a new problem occurs, that is a quantitative model in the implementation of program trading often have a position blast (or burst) incident, the reason is not considered risk measurement of positions, caused ignoring the position risk control. In fact, the risk control for positions is an old problem, because for a long time, investment in the financial sector, the vast majority of the transactions were not realized hedging, to control the risk of positions has always been a thorny issue; if too much emphasized on risk then position too light, it will affect the expected earnings decrease; if too much despised on risk then position too heavy, it will lead to the loss of unexpected increase, the worst is the burst position. Therefore, the greed and fear in the minds of investors will be back and forth with lingering. One solution to this problem is to design a system to control the risk of positions, like a mesh sieve, while trading a contract, screening suitable risk of positions.

And the importance of investment position risk control for institutions is obviously. We can often see that every time after the market suffered a large wave of fluctuation, there are always a few stockjobbers or futures companies or funds companies bankrupted or reorganized. One of the reasons for this is due to heavy risk positions. Review of the financial crisis of 2008, several US financial institutions closed down, one of the reasons is also due to holding heavy risk positions of Subprime Mortgage Bonds.

Design Idea

If the mesh is the focus of a sieve design, then to design a position risk control system should focuses on the measurement of suitable risk for appropriate positions. Deal with the quantity problems need to use mathematical methods, provided that the design of the mathematical model has a financial significance, namely the need for using financial engineering techniques to quantify the process. Model design should consider two factors: first factor, trading conditions given the market running environment, and second, different risk preferences of different investors' personality factor. Thus, optimal decision making method can be used for the factor 1, loss limit method for the factor 2. So that from the two aspects to design two models in two ways, then superimpose the two models to form a combined model will finally solve a suitable position; turn to make the above method in the form of computer program called measurement (or metering) module, which will put tedious calculation process to computer processing; and creating a management module, as a control center in the form of input and output page information to manage the interactive measurement module, so that the system can run independently; to improve the response speed of the system to meet the rapid trading, further you need to make an interface module for connecting the order system (order system refers to transaction terminals of Exchange membership companies to provide customers with a single software, the industry's common with SunGard, Mytrader and Hundsun, etc.). When the appropriate position value metered by the measurement module, the management module converts it into concrete contract: the number of lots, and through the interface module direct import to the order system to deal.

Solution

The overall composition of the system shown in FIG. 1, wherein the measurement module and management module are the core part of the system, through the interface module connected to the order system (or embedding), jointly running on the computer operation system, the order system connected to the internet connection of the remote Exchange membership company's server by computer. The user through the computer controls the system, realizes the system function by way of information input and output.

Wherein the measurement module is responsible for metering risk suitable positions constituted by three sub-modules, named PV sub-module, PN sub-module and PVN sub-module, each sub-module consists of a mathematical model of financial significance, each of the mathematical model contains a set of calculation method, described in detail below, respectively.

PV sub-module is constituted by PV model, PV model is used to describe a risk/reward relationship with positions under market running environment of transactions, so as to find out the best risk-benefit (or income) ratio of position under trading condition, and that is the position coefficient V₀.

Model representation is: Fᵣ=(1+αIVr)^{p}(1−IVr)^{q}

wherein all variables are positive values have the following meanings:

Fᵣ expected return index

I=1/g contract financial leverage

g=1/I contract margin percentage

V Position percentage

P=1−q accuracy

q=1−P inaccuracy

R=rIV potential loss rate

r=Ir₀−r₋ I/r₀ contract stop loss rate, r₀ current price, r₋ stop loss price

α=|r₊→r₀|/|r₀→r₋| the ratio of profit and loss on transaction contract

α hereinafter referred to the profit and loss ratio, r₊ take profit price, shortly win bit r₊ and stop bit r₋.

Fᵣ to V differential calculus, the first derivative is obtained; make it to zero to get the V value when Fᵣ is maximum, the obtained value V is the best value V₀, V₀=[(α+1)p−1]/rIα, then generate the substitution R=rIV, obtained R₀=P−(1−P)/α=P−q/α, then got V₀=R₀/Ir=gR₀/r.

V₀ represents the best value position under trading conditions, hereinafter referred to as the position coefficient, R₀ represents the magnitude of the optimum potential loss under trading conditions, hereinafter referred to as potential loss coefficient; take profit price (bit) r₊ and stop loss price (bits) r₋ called trading condition parameters or simply trading parameters.

As shown in FIG. 2, where the horizontal axis represents V, and the vertical axis represents Fᵣ, the intersection of the curve with the vertical axis is a, and the intersection with the horizontal axis is d, the inflection point is b, and through a point parallel to the horizontal axis linear intersection is c, Fᵣ has a maximum value at the inflection point b, where the horizontal axis corresponds to the position V₀ is optimum, and contribution margin position at this time is zero, in Pareto optimal state; the left ab segment contribution margin position is positive, the right bcd segment contribution margin position is negative, and accelerated increased, break-even point is the point c, d point is the burst point, namely blow-up here.

The calculations are in three steps, first to calculate r, the contract stop loss rate and α, the ratio of profit and loss, then to calculate the potential loss coefficient R₀, the final calculation is the position coefficient V₀.

PN sub-module is constituted by the PN model, used to describe the different personality of different investor' s risk appetite preference impacting on investment positions or limitation of actions, so as to calculate the preference coefficient n corresponding accordingly.

The risk appetite of investors is usually measured by the degree of their patience (or tolerance) for loss. Set the maximum loss limit of each transaction Max I<L, where I represents each failure trading loss rate, L represents the impassable limit of loss rate value, namely the theoretical limit value, such as L=5% or 10%, it can be different according to the different risk preference of the specific investor, under this restriction, the use of funds is corresponding restricted, set: when the proportion of funds is n, can make the maximum potential loss rate into the risk preference constrained range, then the model representation is expressed as:

1/n=Max R₀/Max I

In the above calculation R₀=P−(1−P)/α, Max R₀<P and infinitely close to P, which limits the P.

As shown in FIG. 3, where the horizontal axis represents α, the vertical axis represents R₀, dashed line is P value, indicating that the transaction with the improvement of trading condition, α value increases, the curve R₀ value closes to but does not exceed the value P, that means the potential loss will not exceed the accuracy, on this account the model is reasonable and security, illustrated the effectiveness of setting the L value limit. That is, under any circumstances, no matter how good trading condition is, the potential risk of loss must be within the constrained limit. Because in an efficient market environment, no one can do one hundred percent accuracy (Even the prominent American Long-Term Capital Company collapsed because of the occurrence of small probability event), any participant must take risks, the key issue is the risk they assume to take must be within the range that they can withstand.

So you got: n=Max I/Max R₀=L/p

Hereinafter referred to as n for the risk appetite personalized adjustment coefficient, shortly individual reference coefficient or preference coefficient. Loss limits L and accuracy P called individual reference parameters or preference parameters. About the values of the accuracy P, that can be used by objective methods, namely historical statistics made; can be used by subjective methods, that analysis and forecasting made; also be a combination of both.

PVN sub-module is constituted by PVN model, superimposed of the above two models, used to describe the different risk preference of investors in different trading conditions for the optimal risk-benefit ratio positions V algorithm, that means PN model constrains PV model, and its meaning is using parts of the funds to take the risk fluctuation in order to smooth the overall volatility, the model is expressed as V=nV₀

Here, V is the best (optimum) position, its figurative physical meaning is: the volatility of the PV model is compressed in the channel range defined by the PN model, and the channel range can be adjusted according to preference coefficient elastically, so as to achieve the optimal benefit within a limited and adjustable loss risk.

Taking substitution of the above values n and V₀, then got: V=Lg(αp+p−1)/αrp.

In summary the measurement module, basically a method of a combination of a set of steps of calculations of a series of mathematical models contained financial significance, its manifestations are three models based on three modules; Its essential role is using mathematical tools as a technical means to achieve financial significance, namely screening suitable risk number of values of appropriate positions.

The management module is the control center of the system, responsible for data distribution, calls, conversion, interactive page generation management and coordination functions. First, when the user (investor) starting the system, the management module boots to the information input interface, the input information such as trading condition and personal preference parameter values assigns to the measurement module, while calls transaction contract information within the order system via the interface module: price, margin rate, the maximum number of transactions, and offers the data to the measurement module; then converts the optimum position value which calculated by the measurement module into the number of transaction contracts, generating information output page, prompting the user (investor) how much good number of lots for the current contract, if the user clicks to confirm it exists in the form of orders into the order system via the interface module to deal.

The interface module is responsible for communication connected with the order system, (on the connection with the order system can also adopt the mode of embedding, taking the core part of the system directly embedded into the order system to become one big module of its functional part, the same principle only slightly different form, relatively speaking, easier way to embed as adopted by embedded directly without passing through the interface module.) to establish a set of communication protocols in the interface module, namely a set of instructions or directives that correspond to the orders of the order system, allows the system to order the order system access and operation; direct call via data access, reduced manual input links and improved the operating speed; when the optimum position value V calculated by the measurement module, the management module converts it in terms of transaction lots of the corresponding contract, at the same time via the interface module the number of transaction lots is imported into the order system to deal, thus to achieve rapid execution of trading orders. In addition, the interface module is also responsible for the connection with different computer operation systems (including mobile phones), but can also access a quantitative model of program trading here as its extension.

Detailed block diagram of the logical structure of the system see FIG. 4. All the question marks are required to input, a total of eight; when establishing a connection with the order system, there are four can be called directly: the trading contract y, contract margin g, contract price r₀, and the available maximum number of lots S₀; the manual input are four, the preference parameters: L and P, and trading parameters: take profit bits r₊ and stop loss bits r₋.

Executive Means

As illustrated the system running processes or specific implementation steps shown in FIG. 4:

Step one, starting login the system when the order system is in the order status online, the management module boots to the information input page;

Step two, input preference parameter values: loss limit L and accuracy P, then the system management module will give the data to the measurement module, the measurement module calls PN sub-module using PN model to calculate the preference coefficient n=L/P, and the result data is given to PVN sub-module; this time the management module activates the order system via the interface module to prepare for the following data calls and order executions;

Step three, select contract, the management module via the interface module accesses the order system to provide information for the user to choose contracts, input trading condition parameters when the contract is selected win bit r₊ and stop bit r₋, this time the management module via the interface module requests the order system data: the current contract price r₀ and margin rate g, and the data is given to the measurement module, the measurement module calls PV sub-module using PV model, first calculates the magnitude of the contract stop loss rate r=|r₀−r₋|/r₀ , and the profit and loss ratio α=|r₊−r₀|/|r₀−r₋|, followed by potential loss coefficient R₀=P−(1−p)/α, finally calculates the position coefficient V₀=gR₀/r, and the result is given to the PVN sub-module;

Step four, PVN sub-module, after receiving the data, using PVN model to calculate the optimal position value V=nV₀, and the result is given to the management module;

Step five, in the order system, the management module reads the maximum number of lots of tradable contract S₀ data through the interface module, and then converts the position value V of the specific contract traded in terms of the number of lots S=VS₀;

Step six, the management module output: generating trading execution page, showing S, the best number of lots for transaction which risk is appropriate;

Step seven, the user clicks to confirm the order generation and to execute it into the order system via the interface module to deal; or clicks cancel to discard and return.

### EXAMPLES

### Example 1

An investor using this systematic approach, trading HS300 (China stock index futures of Shanghai and Shenzhen 300), given its capacity of 10 million account funds, accuracy is 50%, the maximum loss of risk appetite for each transaction is 5%, Select contract IF1407, contract current price is 2120, contract margin is 10%. the investor, based on some kind of analysis, to determine to get involved in bull operations, set stop loss bit 2100, take profit bit 2150, making buying operation.

The investor (user) uses this risk control system, the process is as follows:

1, when the order system is online, starts the system, accesses to the information input page;

2, enters preference parameter values: loss limit L=0.05, accuracy P=0.5;

3, selects the contract if1407, inputs trading condition parameters: take profit bit r₊=2150 and loss stop bit r₋=2100;

4, the system generates trading execution page, showing the optimum number of lots 27.8 (decimal reserved bit processing according to Exchange regulations, such as requiring rounding then take 27 lots);

5, clicks OK to perform the transaction, or clicks cancel to discard and return.

In this example, the internal operation of the system processing, calculated as follows: (users saw the result, but not the process.)

1, n=L/P=0.05/0.5=0.1

2, r=(2120−2100)/2120=0.943%

3, α=(2150−2120)/(2120−2100)=30/20=1.5

4, R₀=P−(1−P)/n=0.5−0.5/1.5=0.1667

5, V₀=gR₀/r=10%*0.1667/0.943%=1.77

6, V=nV₀=0.1*1.77=17.7%

7, S=S₀V=17.7%*10,000,000/(2120*300*10%)=157.23*17.7%=27.8

### Example 2

In the above example, the stop loss bit from 2100 change to 2110, the others unchanged, the operating procedure is as follows:

1, when the order system is online, starts the system, accesses to the information input page;

2, inputs preference parameter values: loss limit L=0.05, accuracy P=0.5;

3, selects the contract if1407, inputs the trading condition parameters: take profit bit r₊=2150 and loss stop bit r₋=2110;

4, the system generates trading execution page, showing the optimal number of lots 110;

5, clicks to complete the deal, or clicks to cancel and return.

In this example, the internal operation of the system processing, calculated as follows:

1, n=L/P=0.05/0.5=0.1

2, r=(2120−2110)/2120=10/2120=0.4717%

3, α=(2150−2120)/(2120−2110) 30/10=3

4, R₀=P−(1−P)/α=0.5−0.5/3=0.3333

5, V₀=gR₀/r=10%*0.3333/0.4717%=7

6, V=nV₀=0.1*7=70%

7, S=S₀V=70%*10,000,000/(2120*300*10%)=157.23*70%=110

Beneficial Effect

In the above two cases, the potential loss of the former is rIV=nR₀=1.667%, the potential gain is αnR₀=2.5% (i.e. investment failure will lose 1.667%, investment success will win 2.5%); the potential loss of the latter is rIV=nR₀=3.333%, the potential gain is αnR₀=10% (i.e. investment failure will lose 3.333%, investment success will win 10%). Both potential losses are limited to less than 5%. So the investor doesn't have to be fear, because the risk can be tolerance; and also does not have to be greed, because it is the optimum return within the risk tolerance, intending to improve the income need to take a greater risk and to improve the relevant trading conditions. The latter's risk and benefit are both higher than the former, because the trading condition of the latter is better than the former, the stop loss bit is only half of the former (0.4717%/0.943%=½), a doubling of the profit and loss ratio (3/1.5=2), of cause the latter should be heavily loaded. So, trading condition excellent, position is relatively heavy; poor trading condition, position is relatively light. But both positions are the best, because the position coefficient values V₀ of both are in their Pareto optimal states, according to the PV model, Pareto optimal state represents the best risk-benefit ratio. It should be noticed here: the latter is not two times the value of the position than the former, because the relationship is not linear. Also according to PN and PVN models, risk appetite large, relatively heavy position; risk appetite small, relatively light position. Models are intuitive, which are no longer need to illustrate. In short, under the dual constraints of PN and PV models, the investment positions which passed though the risk control system, far away from the burst point, high margin of safety, and the value of optimum, achieved the optimal returns within the limited scope of risks.

### SUMMARY

To sum up the position risk control system, referred to PVN system, has achieved the proposed filtering function, screened out suitable risk positions, overcame the greed and fear, in preventing position blast (or burst) while achieving the optimum return within the limited scope of risk, improved the efficiency of investment. And by means of the use of computer, making it easy to operate, fast response and practical. Currently, billions of investors in the world are computer user. So, its application prospect is broad.

### BRIEF DESCRIPTION OF THE DRAWINGS

FIG. 1 is the system composing configuration with running environment relations; FIG. 2 is the function of expected return index F, shape graph; FIG. 3 is the function of potential loss coefficient R₀ graph; FIG. 4 is the logic diagram of the system processing and running.

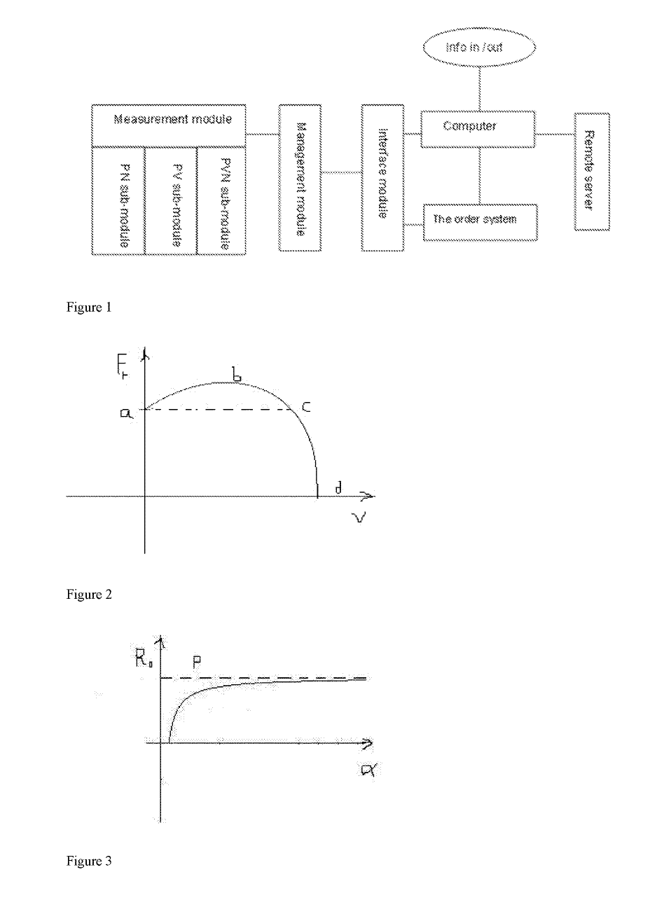

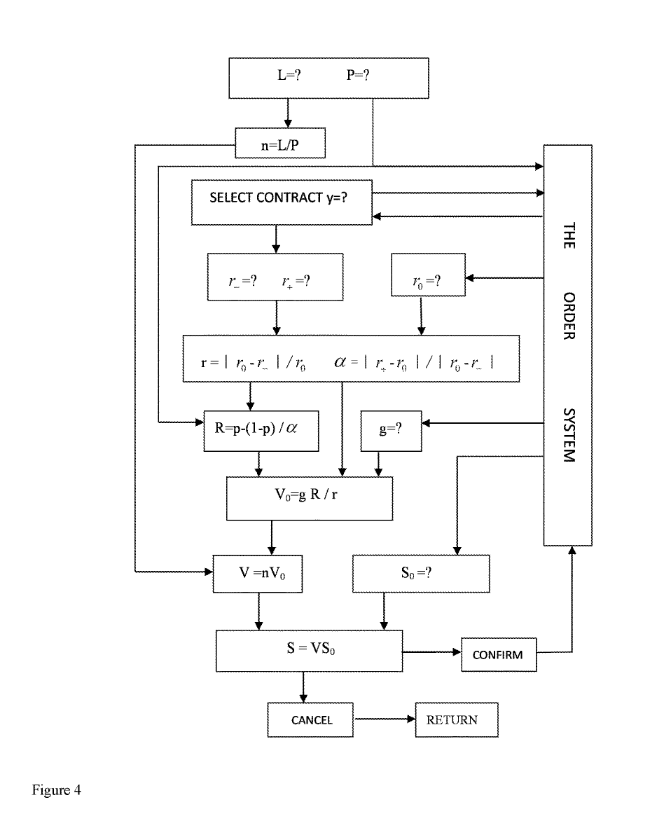

1. A method for controlling investment position risks, wherein the position risk control process includes the following steps:
Step one, setting preference parameter values: loss limit L and accuracy P, using PN model calculates the preference coefficient n=L/P;
Step two, setting trading parameters: take profit bits r₊ and stop loss bits r₋, using PV model to calculate as follows: First, calculating the stop loss rate of the contract r=|r₀−r₋|/r₀, where r₀ represents the current contract price; second, calculating the ratio of profit and loss α=|r₊−r₀|/|r₀−r₋|, and the potential loss coefficient R₀=P−(1−p)/α; finally calculating the position coefficient V₀=gR₀/r, wherein g represents transaction contract margin rate;
Step three, using PVN model calculates the optimum position value V=nV₀;
Step four, converting the optimum position value V into the number of lots for the transaction contract: S=VS₀; where S₀ represents the maximum number of lots for the transaction contract available;
Step five, importing the S value to the order system to achieve a deal.

2. A system for controlling investment position risks, characterized in applying the method that right 1 described, it is presented in the form of a computer program implementing the method, by means of computer application software product.
